(19) United States
(12) Patent Application Publication
(10) Pub. No.: US 2015/0310335 A1
(43) Pub. Date: Oct. 29, 2015

(54) DETERMINING A PERFORMANCE PREDICTION MODEL FOR A TARGET DATA ANALYTICS APPLICATION

(71) Applicant: International Business Machines Corporation, Armonk, NY (US)

(72) Inventors: Liya Fan, Beijing (CN); Chang Sheng Li, Beijing (CN); Jing Min Xu, Beijing (CN); Lin Yang, Beijing (CN)

(21) Appl. No.: 14/689,073

(22) Filed: Apr. 17, 2015

(30) Foreign Application Priority Data
Apr. 29, 2014 (CN) 201410177382.5

(51) Int. Cl. G06N 5/04; G06N 99/00

(52) U.S. Cl. CPC G06N 5/04; G06N 99/005

(57) ABSTRACT

A performance prediction model for a target data analytics application, where: (i) a reference data analytics application similar to the target data analytics application is determined; (ii) a configuration-performance data pair of the target data analytics application are acquired; and (iii) the performance prediction model for the target data analytics application is determined based on the configuration-performance data pair of the target data analytics application and a configuration-performance data pair of the at least one reference data analytics application. This can reduce the time required to accumulate the configuration-performance data pairs for determining the performance prediction model by combining the configuration-performance data pairs of the existing data analytics applications, thereby accelerating determination of the performance prediction model.

### BACKGROUND

The present invention relates to data analytics applications, and more specifically, to a method for determining a performance prediction model for a target data analytics application and an apparatus thereof.

Typically, a data analytics application is an application that regards data as an object and analyzes and processes the data. The data analytics application, especially the analytics application for Big Data Service, has become a primary application in distributed systems such as a cloud computing system. There commercially available Big Data platforms. Typically these platforms provide: (i) a distributed system infrastructure capable of distributed processing massive amounts of data; and (ii) a platform for developing and running various applications that process Big Data (for example, the MapReduce application, which is a software architecture usable for parallel operation of the massive data, and can be used to implement the data analytics application for Big Data).

To predict execution of the data analytics application, typically a performance prediction model for the data analytics application is built. The performance prediction model for the data analytics application is a model for predicting execution performance, for example, time required for executing the data analytics application once, processing speed and so on, of the data analytics application. As a more specific example, for running MapReduce on one commercially available Big Data platform, a predictor of the performance prediction model for the data analytics application may be resource allocation of the Big Data platform. This resource allocation may include: (i) the type of the underlying virtual machines, the size of a constructed cluster and so on, and (ii) the platform's configuration, such as block size and number of reducers for a specific job and so on. The target of the performance prediction model is an end user interested metric, for example the duration of data processing and the cost that needs to be covered, etc.

There are known approaches to build such performance prediction models. One is called the “white-box” modeling approach, which is to build a performance prediction model for a data analytics application by thoroughly investigating inner logic of the data analytics application.

Another approach is a “black-box” modeling approach that uses machine learning techniques to build a regression model. Although such modeling approach does not require parsing of the structure and inner mechanism of the data analytics application, it requires collecting a large amount of existing performance data of the data analytics application for learning. Because the factors that affect the performance of the data analytics application come from the whole software and hardware stack of the data analytics application, the performance regression is typically conducted in a multi-dimensional space.

### SUMMARY

According to an aspect of the present invention, there is a method, computer program product and/or system for determining a performance prediction model for a target data analytics application that performs the following operations (not necessarily in the following order): (i) selecting a first reference data analytics application, from a plurality of data analytics application, with the selection being based, at least in part, on similarity to the target data analytics application; (ii) acquiring a configuration-performance data pair of the target data analytics application, the configuration-performance data pair including configuration data of the target data analytics application's own runtime environment and performance data of the target data analytics application in its own runtime environment; and (iii) determining the performance prediction model for the target data analytics application based, at least in part, on the configuration-performance data pair of the target data analytics application and a configuration-performance data pair of the first reference data analytics application.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system/server which is applicable to implement the embodiments of the present invention;

FIG. 2 shows a flowchart of the method for determining a performance prediction model for a target data analytics application according to an embodiment of the present invention;

FIG. 3 is a flowchart of the process of determining a reference data analytics application in the embodiment shown in FIG. 2;

FIG. 4 is a flowchart of the process of determining a performance prediction model for a target data analytics application by using parameter-based transfer learning in the embodiment shown in FIG. 2; and

FIG. 5 is a schematic block diagram of the apparatus for determining a performance prediction model for a target data analytics application according to an embodiment of the present invention.

### DETAILED DESCRIPTION

Some embodiments of the present disclosure may determine a performance prediction model for a data analytics application quickly and accurately. Some embodiments of the present disclosure provide a method and an apparatus for determining a performance prediction model for a target data analytics application.

According to one embodiment of the present invention, there is provided a method for determining a performance prediction model for a target data analytics application, which includes the following operations (not necessarily in the following order): (i) determining at least one reference data analytics application similar to the target data analytics application among existing data analytics applications; (ii) acquiring a configuration-performance data pair of the target data analytics application, the configuration-performance data pair including configuration data of the target data analytics application's own runtime environment and performance data of the target data analytics application in its own runtime environment; and (iii) determining the performance prediction model for the target data analytics application based on the configuration-performance data pair of the target data analytics application and a configuration-performance data pair of the at least one reference data analytics application.

According to another embodiment of the present invention, there is provided an apparatus for determining a performance prediction model for a target data analytics application. The apparatus includes: (i) a reference data analytics application determining module configured to determine at least one reference data analytics application similar to the target data analytics application among existing data analytics applications; (ii) a data acquiring module configured to acquire a configuration-performance data pair of the target data analytics application, the configuration-performance data pair including configuration data of the target data analytics application's runtime environment and performance data of the target data analytics application in its own runtime environment; and (iii) a model determining module configured to determine the performance prediction model for the target data analytics application based on the configuration-performance data pair of the target data analytics application and a configuration-performance data pair of the at least one reference data analytics application.

Some embodiments of the present disclosure may include one, or more, of the following characteristics, features and/or advantages: (i) acquire the performance prediction model for the target data analytics application with less amount of configuration-performance data pairs of the target data analytics application by combining the configuration-performance data pairs of the existing data analytics applications; (ii) reduce the time required to accumulate the data for building the performance prediction model for the target data analytics applications to accelerate the modeling process of the target data analytics application; and/or solve (iii) the problem of a low time-to-value of the data analytics application caused by time-consuming data accumulation in the prior art.

Some embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

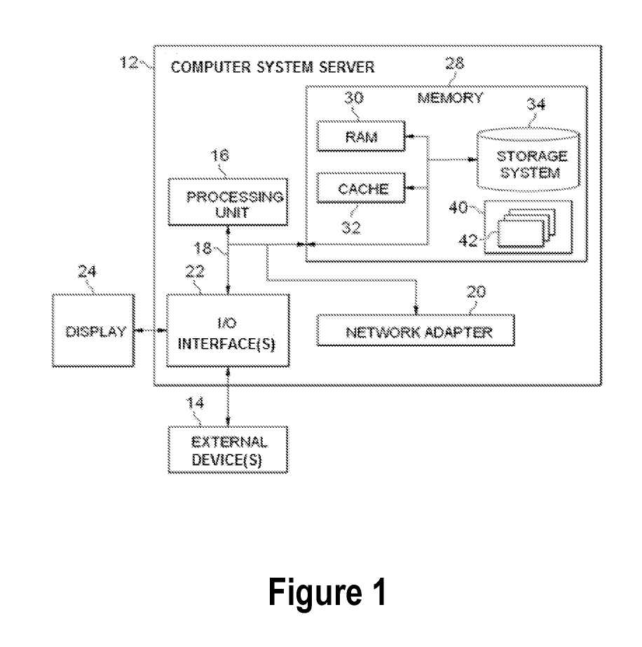

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (for example, a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (for example, at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (for example, network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (for example, the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

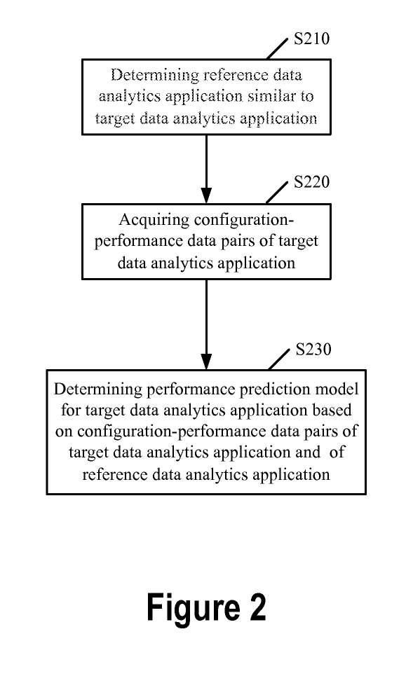

FIG. 2 shows a flowchart of the method for determining a performance prediction model for a target data analytics application according to an embodiment of the present invention. This embodiment will be described in detail below with reference to the drawings.

Some embodiments utilize configuration-performance data pairs of existing configuration data analytics applications, thereby reducing the amount of configuration-performance data pairs required to be developed for the target data analytics application (that is, the data analytics application for which the performance prediction model needs to be built) to determine the performance prediction model for the target data analytics application by means of a transfer learning technique.

The transfer learning technique is a machine learning technique which aims to extract knowledge from one or more source tasks and apply the extracted knowledge to a target task. In this embodiment, through the transfer learning, knowledge is extracted from the configuration-performance data pairs of the existing data analytics applications and is used to build the performance prediction model for the target data analytics application.

As described above, a performance prediction model for a data analytics application is a model used to predict execution performance of the data analytics application in the case where configuration of the runtime environment (including hardware and software) of the data analytics application changes. The execution performance of the data analytics application includes, for example, execution time and processing speed of the data analytics application.

As shown in FIG. 2, in step S210, at least one reference data analytics application similar to the target data analytics application is determined among the existing data analytics applications. With this step, the existing data analytics applications to be used in the transfer learning, that is the reference data analytics applications, can be determined.

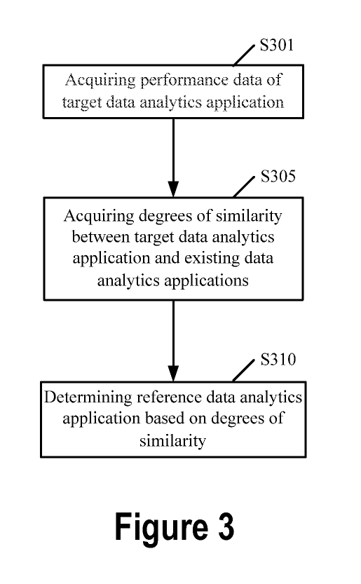

In step S210, the determination of the reference data analytics application may be implemented by comparing a similarity between the target data analytics application and the respective existing data analytics applications. FIG. 3 shows a flowchart of one embodiment of a method for performing step S210.

In an embodiment, as shown in FIG. 3, in step S301, the performance data of the target data analytics application in the same runtime environment as that of the existing data analytics applications is acquired. In this embodiment, the performance data is the data associated with the execution performance of the data analytics application, and can reflect characteristics of the data analytics application, for example, compute intensiveness, I/O operation capability, etc. Typically, a data analytics application may be firstly categorized by the software framework type, like MapReduce type or MPI type. In the same type of software framework, different data analytics applications present different characteristics. For example, in the MapReduce type, data analytics applications may differ in many aspects like CPU or I/O intensity, complexity of map/reduce functions etc. These characteristics may be quantified by the performance data acquired from counters and execution logs of the operating platform (for example, a commercially-available Big Data platform)) of the data analytics application.

In this step, first, the target data analytics application runs in the same runtime environment as that of the existing data analytics applications. The use of the same runtime environment is to rule out the impacts caused by different environments on the execution performance of the data analytics application. Next, size information and processing time information of data processed by the target data analytics application in runtime are collected. Typically, the size information and the processing time information of the data processed by the target data analytics application are recorded, as basic information, in the counters and the execution logs for recording the running of the data analytics application in the runtime environment where the data analytics application resides. Then, the performance data is calculated based on the size information and the processing time information of the processed data.

The process of acquiring the performance data of the target data analytics application will be illustrated below with the application MapReduce on a platform called “Big Data Platform” as an example. Typically, a job of the MapReduce application may include three phases: Map stage, Shuffle phase, and Reduce phase. Therefore, the performance data of the MapReduce application may also be acquired and calculated from the three stages respectively.

In this example, the performance data may be set as the data indicating the time information related to execution of the job of the MapReduce application, and these performance data can quantify and indicate an operation on each key-value pair and I/O operations in the MapReduce application.

In the Map phase, the following basic information may be collected from the Big Data platform counters:
total number Rᵢₙ of input records (input key-value pairs);
size Sᵢₙ of input files;
size S_{mid} of intermediate outputs (intermediate key-value pairs); and
total number R_{mid} of intermediate key-value pairs.

Moreover, the following basic information may be collected from the execution logs:
total time Tₘ for processing input records;
total time Tₘᵢₙ reading input files; and
total time Tₘₒᵤₜ for writing intermediate outputs.

Then, the above collected basic information is calculated to acquire the performance data in the Map phase. The performance data in the MAP phase may be at least one of Tₘ/Rᵢₙ, Tₘᵢₙ/Sᵢₙ, and Tₘₒᵤₜ/S_{mid}, wherein Tₘ/Rᵢₙ, represents the average time for processing one input key-value pair, Tₘᵢₙ/Sᵢₙ represents the time for reading an input file per unit size, and Tₘₒᵤₜ/S_{mid} represents the average time for writing an intermediate key-value pair per unit size.

Next, in the Shuffle stage, the following basic information may be collected from the execution logs:
total time Tₛᵢₙ for acquiring intermediate outputs;
total time Tₛ for sorting intermediate key-value pairs; and
total time Tₛₒᵤₜ for writing sorted key-value pairs.

Then, the performance data in the Shuffle phase is calculated based on the above collected basic information. The performance data in the Shuffle phase may be at least one of Tₛ/R_{mid}, Tₛᵢₙ/S_{mid}, and Tₛₒᵤₜ/S_{mid}, wherein Tₛ/R_{mid} represents the average time for sorting one intermediate key-value pair, Tₛᵢₙ/S_{mid} represents the time for acquiring an intermediate key-value pair per unit size, and Tₛₒᵤₜ/S_{mid} represents the time for writing an intermediate key-value pair per unit size.

Thereafter, in the Reduce phase, the following basic information may be collected from the execution logs:
total time Tᵣ for processing sorted key-value pairs;
total time Tᵣₒᵤₜ for writing output files; and
size Sᵣₒᵤₜ of output files.

Then, the performance data in the Reduce phase is calculated based on the above collected basic information. The performance data in the Reduce phase may be at least one of Tᵣ/R_{mid} and Tᵣₒᵤₜ/Sᵣₒᵤₜ, wherein Tᵣ/R_{mid} represents the average time for processing one intermediate key-value pair, Tᵣₒᵤₜ/Sᵣₒᵤ represents the time for writing an output file per unit size.

Therefore, the performance data of the MapReduce application may be at least one of the performance data in the Map stage, the performance data in the Shuffle phase, and the performance data in the Reduce stage.

A person skilled in the art will appreciate that other performance data may also be used except the above performance data.

Similarly, the performance data of the existing data analytics applications may be also acquired.

Next, in step S305, degrees of similarity between the target data analytics application and the existing data analytics applications are acquired according to the performance data of the target data analytics application and the performance data of the existing data analytics applications acquired in step S301. In this step, a conventional method may be used to acquire the degree of similarity. For example, the degree of similarity can be acquired by calculating a Euclidean distance between vectors formed by the performance data. Generally, the shorter the Euclidean distance between the vectors is, the higher the degree of similarity between the vectors is.

Then, in step S310, at least one reference data analytics application is determined according to the degrees of similarity between the target data analytics application and the existing data analytics applications acquired in step S305. For example, the reference data analytics application may be determined as the existing data analytics application having the highest degree of similarity with the target data analytics application. For example, the reference data analytics application may also be determined as the existing data analytics application whose degree of similarity with the target data analytics application exceeds a predetermined threshold. For example, the reference data analytics application may also be determined as a predetermined number of existing data analytics applications having high degrees of similarity with the target data analytics application.

In another embodiment, the existing data analytics applications may be clustered into at least one application cluster in advance. Then, the performance data of the target data analytics application and the performance data of the existing data analytics applications in the at least one application cluster are acquired, and the degree of similarity between the target data analytics application and the at least one application cluster can be acquired based on these performance data. Finally, the reference data analytics applications are determined according to the acquired degree of similarity.

The method of generating the application cluster may be as follows. Firstly, the performance data of the existing data analytics applications is acquired, which may be implemented by monitoring the running of the existing data analytics applications and performing deliberate benchmarking on the existing data analytics applications. Then, the collected performance data is clustered according to characteristics of these existing data analytics applications to obtain application clusters of the existing data analytics applications. The performance data acquiring and clustering process may be carried out continuously in order to expand the application cluster constantly.

The process of acquiring the performance data of the target data analytics application is same as that of acquiring the performance data in the previous embodiment, so the description thereof is omitted here.

When acquiring the degree of similarity between the target data analytics application and the at least one application cluster, the degree of similarity may also be acquired by calculating the Euclidean distance.

In an embodiment, the Euclidean distances between the performance data of the target data analytics application and the performance data of the respective existing data analytics applications in the at least one application cluster are calculated. Then, in each application cluster, the reciprocal of the minimum of the calculated Euclidean distance is determined as the degree of similarity between the target data analytics application and the application cluster.

In another embodiment, the average performance data of each of the at least one application cluster can be calculated firstly. This may be achieved by averaging the performance data of the existing data analytics applications contained in the application cluster. Then, the Euclidean distance between the performance data of the target data analytics application and the average performance data of each application cluster is calculated, and the reciprocal of the calculated Euclidean distance becomes the degree of similarity between the target data analytics application and the application cluster.

Thereafter, the reference application cluster can determined based on the calculated degrees of similarity, and accordingly the existing data analytics applications in the reference application cluster are determined as the reference data analytics applications. For example, the reference application cluster may be determined as the application cluster having the highest degree of similarity with the target data analytics application. For example, the reference application cluster may also be determined as the application cluster whose degree of similarity with the target data analytics application exceeds a predetermined threshold. For example, the reference application cluster may also be determined as a predetermined number of application clusters having high degrees of similarity with the target data analytics application.

Returning to FIG. 2, in step S220, a configuration-performance data pair of the target data analytics application is acquired. In this embodiment, the configuration-performance data pair describes an association between the configuration data of the runtime environment of the data analytics application and the performance data of the data analytics application when running in the corresponding runtime environment. As described above, the target data analytics application's own configuration-performance data pair is necessary as a basis to determine the performance prediction model for the target data analytics application besides the configuration-performance data pairs of the existing data analytics applications. In this embodiment, a plurality of benchmarking can be performed on the target data analytics application to obtain its configuration-performance data pairs, and the configuration of different runtime environment is used for each benchmarking. The number of the benchmarking may be determined according to an accuracy requirement of the performance prediction model and cost for training the performance prediction mode.

Specifically, a plurality of runtime environments is configured for the target data analytics application. The configuration of the runtime environment mainly focuses on aspects that could make the execution performance of the target data analytics application change, and may include resource allocation and platform configuration and so on. Take the MapReduce application on the example platform herein called “Big Data Platform” as an example, the configuration of the runtime environment may include at least one configuration of the following four aspects: 1) Big Data Platform cluster size, which represents the number of hosts contained in the Big Data Platform cluster; 2) input size of the target data analytics application, which represents the size of the data generated and consumed by the target data analytics application; 3) block size, which represents the size of Big Data Platform distributed file system (HDFS) blocks to store the data; and 4) size of reducer, which represents the number of reduce tasks. By changing these configurations, different runtime environments may be acquired.

Thereafter, the target data analytics application runs in the configured runtime environments respectively, and the performance data of the target data analytics application when running in each runtime environment can be obtained. When the target data analytics application runs in a single runtime environment, the size information and processing time information of the data processed by the target data analytics application in runtime may be collected from the counters and the execution logs of the target data analytics application in the runtime environment. Then, the performance data of the target data analytics application in this runtime environment is calculated according to the size information and processing time information of the processed data as collected. Next, the configuration data of the respective runtime environments is associated with the performance data of the target data analytics application in the respective runtime environments correspondingly to form the configuration-performance data pairs of the target data analytics application.

In addition, it is described in the above that the benchmarking is performed on the target data analytics application in a plurality of runtime environments in order to acquire the configuration-performance data pairs, but a person skilled in the art will appreciate that it is also possible to perform the benchmarking on the target data analytics application in a single runtime environment to acquire the configuration-performance data pair.

Next, in step S230, the performance prediction model for the target data analytics application is determined based on the configuration-performance data pair of the target data analytics application acquired in step S220 and the configuration-performance data pair of the at least one reference data analytics application. In this embodiment, the transfer learning technique is used to determine the performance prediction model for the target data analytics application.

As mentioned above, the transfer learning focuses on accumulating knowledge from a source domain and applying the accumulated knowledge to a task in a different but related target domain. In this embodiment, for the target data analytics application, the transfer learning is carried out by using the configuration-performance data pair of the reference data analytics application and the configuration-performance data pair of the target data analytics application, so that the performance prediction model for the target data analytics application can be determined quickly and accurately.

In an embodiment, the performance prediction model for the target data analytics application may be built by using at least one of instance-based transfer learning, feature-based transfer learning, parameter-based transfer learning, and relationship-based transfer learning.

In the instance-based transfer learning, knowledge of instances is transferred, namely, part of the data in the source domain is reused together with part of the data in the target domain. In this case, the data in the source domain is the configuration-performance data pair of the reference data analytics application, and the data in the target data is the configuration-performance data pair of the target data analytics application. These are used as training data to build the performance prediction model for the target data analytics application.

In the feature-based transfer learning, knowledge of feature representations is transferred, which aims to find feature representations that minimize divergence between the source domain and the target domain and model error.

In the parameter-based transfer learning, knowledge of parameters is transferred, which assumes that individual models for related or similar applications should share some parameters or common patterns. The detail of the parameter-based transfer learning will be described later.

In the relationship-based transfer learning, relational knowledge is transferred, which copies relationship in the source domain to the target domain.

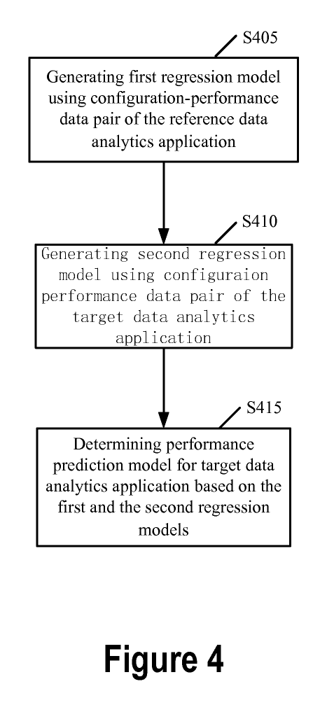

Next, the process of determining the performance prediction model for the target data analytics application by using the parameter-based transfer learning will be described in detail. FIG. 4 shows an illustrative flowchart of the process.

As shown in FIG. 4, in step S405, a first regression model is generated by using the configuration-performance data pair of the at least one reference data analytics application determined in step S210. The first regression model may be generated by using a regression analytics method in the prior art. For example, the first regression model may be expressed as:

f_{S}=g(D_{S}) (1)

where f_{S} represents the first regression model, g(·) represents the existing regression function, Ds represents the configuration-performance data pair of the at least one reference data analytics application. By means of training the regression function using the configuration-performance data pair of the at least one reference data analytics application, parameter values in the regression function can be determined, thereby generating the first regression model.

Then, in step S410, a second regression model is generated by using the configuration-performance data pair of the target data analytics application as collected in step S220. In this step, the second regression model may be generated by using the same regression function as in step S405. The second regression model may be expressed as:

f_{T}=g(D_{T}) (2)

where f_{T} represents the second regression model, g(·) indicates the regression function, D_{T} represents the configuration-performance data pair of the target data analytics application.

As will be appreciated by those of ordinary skill in the art, S405 and S410 may be performed in parallel.

As the target data analytics application is similar to the reference data analytics application, the target data analytics application and the reference data analytics applications can share the same model parameters and patterns. Thus, in step S415, the performance prediction model for the target data analytics application can be determined based on the first regression model and the second regression model. The performance prediction model for the target data analytics application may be expressed as:

f=λf_{S}+(1−λ)f_{T} (3)

where λ represents a contribution of the parameters of the first regression model and the second regression model, which is a value greater than zero and less than one.

Alternatively, normalization may be performed on the configuration-performance data pair of the at least one reference data analytics application prior to generating the first regression model, and may be performed on the configuration-performance data pair of the target data analytics application prior to generating the second regression model. Since the data collected may have different magnitudes, the normalization of the data is necessary. In this step, normalization factor may be a maximum value in these configuration-performance data pairs.

It can be seen from the above description that the method of this embodiment can accelerate the modeling process of the target data analytics application by using the configuration-performance data pairs of the existing data analytics applications as collected in advance and the configuration-performance data pair of the target data analytics application and using the transfer learning technique to build the performance prediction model for the target data analytics application. In the method of this embodiment, since the configuration-performance data pairs of the existing data analytics applications are used in the modeling process of the target data analytics application, compared with the method without using the transfer learning technique in the prior art, the amount of the configuration-performance data pair of the target data analytics application is small, and accordingly the time for acquiring the configuration-performance data pair is short, thereby accelerating the modeling process. With the method of this embodiment, the performance prediction model for the target data analytics application can be determined accurately even in the case where there are fewer available configuration performance data pairs of the target data analytics application.

The method of this embodiment will be described in detail through a specific example below. In this example, the target data analytics application is MapReduce application TeraSort for sorting random data, and the existing data analytics applications are MapReduce application TeraGen for generating random data and MapReduce application WordCount for counting how often a given word occurs in the input. It is assumed that the target of the performance prediction model for the target data analytics application TeraSort is execution time of the target data analytics application TeraSort.

First, the reference data analytics application similar to the target data analytics application TeraSort is determined in the existing data analytics applications TeraGen and WordCount. In this process, the three data analytics applications run in the same runtime environment, and their performance data can be acquired. The runtime environment is, for example, a Big Data Platform type platform with nine hosts having the same configurations, and the three data analytics applications have the same input size. Since TeraGen is the MapReduce application with only Map stage, the performance data of these three data analytics applications can be obtained only from the Map stage. Then, the degrees of similarity between the target data analytics application TeraSort and the existing data analytics applications TeraGen and WordCount are calculated respectively. According to the degrees of similarity, it is found that the degree of similarity between the target data analytics application TeraSort and the existing data analytics application TeraGen is higher, and thus the existing data analytics application TeraGen is determined as the reference data analytics application.

Then, different runtime environments are configured to run the target data analytics application TeraSort. In this example, the configuration of the runtime environment mainly focuses on factors affecting the execution time of the target data analytics application TeraSort. For example, the execution time of TeraSort is affected by the following four factors of the configuration of the runtime environment: 1) number of hosts on the Big Data Platform type platform; 2) size of data processed by TeraSort; 3) size of HDFS block; 4) number of reduce tasks in reducer. For example, it is possible to configure four types of Big Data Platform type platforms having 5, 10, 20, and 40 hosts of the same configuration, the size of data processed may be 1 GB, 10 GB, 50 GB, 100 GB, 200 GB, 400 GB, 500 GB, 600 GB, 800 GB, and 1000 GB, the block size may be 64 MB, 128 MB, 256 MB, and 512 MB, the number of reduce tasks may be 1-10, 15, 20, 25, 30, 35, and 40. The configuration-performance data pairs of the target data analytics application TeraSort can be acquired by running the target data analytics application TeraSort in the above configured runtime environments. The configuration-performance data pairs of the reference data analytics application TeraGen may be collected in advance, and may also be acquired by running in the above runtime environments.

Then, a first regression model can be generated by using the configuration-performance data pairs of the reference data analytics application TeraGen with the above Equation (1). Meanwhile, a second regression model can be generated by using the configuration-performance data pairs of the target data analytics application TeraSort with the above Equation (2). Finally, the performance prediction model for the target data analytics application TerSort can be determined with the above Equation (3), where λ is set to 0.5, for example.

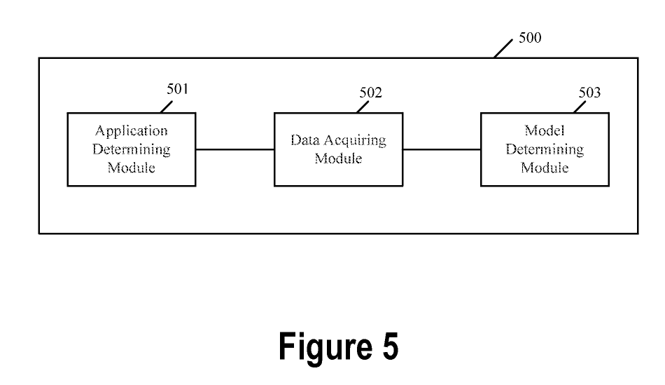

Under the same inventive concept, FIG. 5 shows a schematic block diagram of the apparatus 500 for determining a performance prediction model for a target data analytics application according to an embodiment of the present invention. This embodiment will be described in detail below in conjunction with the drawings, wherein the descriptions for the same parts as those in the previous embodiment are omitted properly.

As shown in FIG. 5, apparatus 500 includes: (i) application determining module 501 configured to determine at least one reference data analytics application similar to the target data analytics application among existing data analytics applications; (ii) data acquiring module 502 configured to acquire a configuration-performance data pair of the target data analytics application, the configuration-performance data pair including configuration data of the target data analytics application's own runtime environment and performance data of the target data analytics application in its own runtime environment; and (iii) model determining module 503 configured to determine the performance prediction model for the target data analytics application based on the configuration-performance data pair of the target data analytics application and the configuration-performance data pair of the at least one reference data analytics application.

In apparatus 500 of this embodiment, in order to determine the performance prediction model for the target data analytics application, firstly, application determining module 501 determines the reference data analytics application similar to the target data analytics application.

In application determining module 501, an acquiring unit can acquire the performance data of the target data analytics application in the same runtime environment as that of the existing data analytics applications. In the acquiring unit, first, a running unit may first run the target data analytics application in the same runtime environment as that of the existing data analytics applications. The same runtime environment can rule out impacts caused by the different configuration of the runtime environment on the execution performance of the data analytics application. Next, a collecting unit may collect size information and processing time information of data processed by the target data analytics application in runtime. For example, the collecting unit may acquire the size information and processing time information of the data from the counters in the runtime environment and the execution logs of the target data analytics application. Then, a calculating unit may calculate the performance data of the target data analysis application based on the collected size information and the processing time information of the processed data.

Then, a degree of similarity acquiring unit may acquire the degrees of similarity between the target data analytics application and the existing data analytics applications according to the performance data of the target data analytics application acquired by the acquiring unit and the performance data of the existing data analytics applications. In this embodiment, the degree of similarity may be acquired by calculating the Euclidean distance between the vectors formed by the performance data. The degree of similarity acquiring unit may use any method of acquiring a degree of similarity described above.

Then, an application determining unit may determine at least one reference data analytics application according to the degrees of similarity between the target data analytics application and the existing data analytics applications. For example, the reference data analytics application may be determined as the existing data analytics application having the highest degree of similarity with the target data analytics application. For example, the reference data analytics application may also be determined as the existing data analytics application whose degree of similarity with the target data analytics application exceeds a predetermined threshold. For example, the reference data analytics application may also be determined as a predetermined number of existing data analytics applications having high degrees of similarity with the target data analytics application.

Next, data acquiring module 502 collects the configuration-performance data pairs of the target data analytics application. In data acquiring module 502, first, a configuring unit configures a plurality of runtime environments for the target data analytics application. As described above, the configuration of the runtime environment mainly focuses on the aspects that could make the execution performance of the target data analytics application change. Changing the configuration of the runtime environment could make the performance data be various. Then, a running unit runs the target data analytics application in the configured plurality of runtime environments respectively, and an acquiring unit acquires the performance data of the target data analytics application when running in each runtime environment. Then, an associating unit associates the configuration data of the respective runtime environments with the corresponding performance data of the target data analytics application in the respective runtime environments to form the configuration-performance data pairs of the target data analytics application.

Then, the configuration-performance data pairs of the at least one reference data analytics application and the configuration-performance data pairs of the target data analytics application acquired by data acquiring module 502 are provided to module determining module 503, which determines the performance prediction model for the target data analytics application according to these configuration-performance data pairs.

In an embodiment, model determining model 503 determines the performance prediction model for the target data analytics application by using at least one of the instance-based transfer learning, the feature-based transfer learning, the parameter-based transfer learning, and the relationship-based transfer learning. These four types of transfer learning are already described above, and their descriptions are omitted here.

In another embodiment, in model determining module 503, firstly, a generating unit may generate a first regression model by using the configuration-performance data pairs of the at least one reference data analytics application, and generate a second regression mode by using the configuration-performance data pairs of the target data analytics application. The first regression model and the second regression model may be generated by using a regression analytics method in the prior art. Then, a model determining unit determines the performance prediction model for the target data analytics application based on the first and second regression model regression models. For example, the performance prediction model for the target data analytics application may be expressed as f=λf_{S}+(1−λ)f_{T}, where f_{S} represents the first regression model, f_{T} represents the second regression model, λ represents a contribution of the parameters of the first regression model and the second regression model, which is a value greater than zero and less than one.

Additionally, model determining module 503 may further comprises a normalizing unit, which normalizes the configuration-performance data pairs of the at least one reference data analytics application prior to generating the first regression model, and normalizes the configuration-performance data pairs of the target data analytics application prior to generating the second regression model.

It should be noted that apparatus 500 of this embodiment can operationally implement the method for determining a performance prediction model for a target data analytics application in the embodiments shown in FIGS. 2 through 4.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The following paragraphs set forth some definitions for certain words or terms for purposes of understanding and/or interpreting this document.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for determining a performance prediction model for a target data analytics application, comprising:
selecting a first reference data analytics application, from a plurality of data analytics application, with the selection being based, at least in part, on similarity to the target data analytics application;
acquiring a configuration-performance data pair of the target data analytics application, the configuration-performance data pair including configuration data of the target data analytics application's own runtime environment and performance data of the target data analytics application in its own runtime environment; and
determining the performance prediction model for the target data analytics application based, at least in part, on the configuration-performance data pair of the target data analytics application and a configuration-performance data pair of the first reference data analytics application.

2. The method according to claim 1, wherein the selection of the first reference data analytics application includes:
acquiring performance data of the target data analytics application in the same runtime environment as that of the existing data analytics applications;
acquiring degrees of similarity between the target data analytics application and the existing data analytics applications according to the performance data of the target data analytics application and the performance data of the existing data analytics applications; and
determining the first reference data analytics application according to the degrees of similarity between the target data analytics application and the existing data analytics applications.

3. The method according to claim 2, wherein the acquisition of the performance data of the target data analytics application includes:
running the target data analytics application in the same runtime environment;
collecting size information and processing time information of data processed by the target data analytics application; and
calculating the performance data based on the size information and the processing time information of the processed data.

4. The method according to claim 1, wherein the acquisition of the configuration-performance data pair of the target data analytics application includes:
configuring a plurality of runtime environments for the target data analytics application;
running the target data analytics application in the plurality of runtime environments;
acquiring the performance data of the target data analytics application in the plurality of runtime environments; and
associating the configuration data of the plurality of runtime environments with the corresponding performance data in the plurality of runtime environments to form the configuration-performance data pairs.

5. The method according to claim 1, wherein the determination of the performance prediction model for the target data analytics application includes:
determining the performance prediction model for the target data analytics application by using at least one of the following: instance-based transfer learning, feature-based transfer learning, parameter-based transfer learning, and/or relationship-based transfer learning.

6. The method according to claim 1, wherein the determination of the performance prediction model for the target data analytics application includes:
generating a first regression model by using the configuration-performance data pair of the first reference data analytics application;
generating a second regression model by using the configuration-performance data pair of the target data analytics application; and
determining the performance prediction model for the target data analytics application based on the first regression model and the second regression model.

7. The method according to claim 6, wherein the determination of the performance prediction model for the target data analytics application further includes:
normalizing the configuration-performance data pair of the first reference data analytics application prior to generating the first regression model; and
normalizing the configuration-performance data pair of the target data analytics application prior to generating the second regression model.

8. An apparatus for determining a performance prediction model for a target data analytics application, the apparatus comprising:
an application determining module configured to determine a first reference data analytics application, from a plurality of data analytics application, based, at least in part, on similarity to the target data analytics application;
a data acquiring module configured to acquire a configuration-performance data pair of the target data analytics application, the configuration-performance data pair including configuration data of the target data analytics application's own runtime environment and performance data of the target data analytics application in its own runtime environment; and
a model determining module configured to determine the performance prediction model for the target data analytics application based, at least in part, on the configuration-performance data pair of the target data analytics application and a configuration-performance data pair of the first reference data analytics application.

9. The apparatus according to claim 8, wherein the application determining module comprises:
an acquiring unit configured to acquire performance data of the target data analytics application in the same runtime environment as that of the existing data analytics applications;
a degree of similarity acquiring unit configured to acquire degrees of similarity between the target data analytics application and the existing data analytics applications according to the performance data of the target data analytics application and the performance data of the existing data analytics applications; and
an application determining unit configured to determine the first reference data analytics application according to the degrees of similarity between the target data analytics application and the existing data analytics applications.

10. The apparatus according to claim 9, wherein the acquiring unit comprises:
a running unit configured to run the target data analytics application in the same runtime environment;
a collecting unit configured to collect size information and processing time information of data processed by the target data analytics application; and
a calculating unit configured to calculate the performance data based on the size information and the processing time information of the processed data.

11. The apparatus according to claim 8, wherein the data acquiring module comprises:
a configuring unit configured to configure a plurality of runtime environments for the target data analytics application;
a running unit configured to run the target data analytics application in the plurality of runtime environments;
an acquiring unit configured to acquire the performance data of the target data analytics application in the plurality of runtime environments; and
an associating unit configured to associate the configuration data of the plurality of runtime environments with the corresponding performance data in the plurality of runtime environments to form the configuration-performance data pairs.

12. The apparatus according to claim 8, wherein the model determining module is configured to determine the performance prediction model for the target data analytics application by using at least one of instance-based transfer learning, feature-based transfer learning, parameter-based transfer learning, and relationship-based transfer learning.

13. The apparatus according to claim 8, wherein the model determining module comprises:
a generating unit configured to generate a first regression model by using the configuration-performance data pair of the first reference data analytics application, and generate a second regression model by using the configuration-performance data pair of the target data analytics application; and
a model determining unit configured to determine the performance prediction model for the target data analytics application based on the first regression model and the second regression model.

14. The apparatus according to claim 13, wherein the model determining module further comprises:
a normalizing unit configured to normalize the configuration-performance data pair of the first reference data analytics application prior to generating the first regression model, and normalize the configuration-performance data pair of the target data analytics application prior to generating the second regression model.

15. A computer program product for determining a performance prediction model for a target data analytics application, the computer program product comprising a computer readable storage medium having stored thereon:
first program instructions programmed to select a first reference data analytics application, from a plurality of data analytics application, with the selection being based, at least in part, on similarity to the target data analytics application;
second program instructions programmed to acquire a configuration-performance data pair of the target data analytics application, the configuration-performance data pair including configuration data of the target data analytics application's own runtime environment and performance data of the target data analytics application in its own runtime environment; and
third program instructions programmed to determining the performance prediction model for the target data analytics application based, at least in part, on the configuration-performance data pair of the target data analytics application and a configuration-performance data pair of the first reference data analytics application.

16. The product according to claim 15, wherein the selection of the first reference data analytics application includes:
acquiring performance data of the target data analytics application in the same runtime environment as that of the existing data analytics applications;
acquiring degrees of similarity between the target data analytics application and the existing data analytics applications according to the performance data of the target data analytics application and the performance data of the existing data analytics applications; and
determining the first reference data analytics application according to the degrees of similarity between the target data analytics application and the existing data analytics applications.

17. The product according to claim 16, wherein the acquisition of the performance data of the target data analytics application includes:
running the target data analytics application in the same runtime environment;
collecting size information and processing time information of data processed by the target data analytics application; and
calculating the performance data based on the size information and the processing time information of the processed data.

18. The product according to claim 15, wherein the acquisition of the configuration-performance data pair of the target data analytics application includes:
configuring a plurality of runtime environments for the target data analytics application;
running the target data analytics application in the plurality of runtime environments;
acquiring the performance data of the target data analytics application in the plurality of runtime environments; and
associating the configuration data of the plurality of runtime environments with the corresponding performance data in the plurality of runtime environments to form the configuration-performance data pairs.

19. The product according to claim 15, wherein the determination of the performance prediction model for the target data analytics application includes:
determining the performance prediction model for the target data analytics application by using at least one of the following: instance-based transfer learning, feature-based transfer learning, parameter-based transfer learning, and/or relationship-based transfer learning.

20. The product according to claim 15, wherein the determination of the performance prediction model for the target data analytics application includes:
generating a first regression model by using the configuration-performance data pair of the first reference data analytics application;
generating a second regression model by using the configuration-performance data pair of the target data analytics application; and
determining the performance prediction model for the target data analytics application based on the first regression model and the second regression model.
